(19) United States
(12) Patent Application Publication
(10) Pub. No.: US 2005/0187668 A1
(43) Pub. Date: Aug. 25, 2005

(54) System or method for loading software onto a vehicle

(76) Inventor: Joseph W. Baumgarte, Kokomo, IN (US)

Correspondence Address: STEFAN V. CHMIELEWSKI;DELPHI TECHNOLOGIES, INC., Legal Staff Mail Code: CT10C, P.O. Box 9005, Kokomo, IN, 46904-9005, US

(21) Appl. No.: 10/784,491

(22) Filed: Feb. 23, 2004

(51) Int. Cl. G06F 19/00

(52) U.S. Cl. 701/1

(57) ABSTRACT

The disclosure describes a system or method for distributing software intended for use in vehicles, including but not limited to navigation applications. The distribution system allows individual vehicle owners, as well as third-parties such as automotive dealerships and mechanics, to load software onto vehicle applications in a more efficient manner. Instead of loading the software off of a CD-ROM using a CD player within the vehicle, software files can be received by a general purpose computer accessible by the recipient of the software. The software can then be loaded onto the vehicle hard drive utilizing the superior computing power of the general purpose computer. In order to prevent the unauthorized copying and distribution of the software upgrades, the software can be encrypted using some type of unique identifier, such as a vehicle identification number (VIN).

### BACKGROUND OF THE INVENTION

1. Technical Field

The present invention relates generally to systems or methods for distributing software from a “source” to a “target” (collectively a “software distribution system”). More specifically, the present invention relates to software distribution systems where the “target” is a vehicle.

2. Background of the Invention

Modern vehicles are increasingly reliant upon electronic components that utilize various software applications. Such applications can provide a wide variety of different functions, including “fundamental” vehicle functions such as fuel injection and breaking applications, “discretionary” applications related to use of the vehicle such as navigation applications, and purely “recreational” applications having nothing to do with the vehicle itself, such as DVD players, video games, and various other entertainment options. Software applications are an increasingly important category of vehicle components.

It is often necessary to modify the software files utilized by the vehicle. Sometimes, the desire for change is motivated by a defect or “bug” in a current version of the software functionality. In other instances, the desire for change can be grounded in the desire to add functionality or upgrade the existing functionality of the software application. For example, a subscriber to a navigation service may require periodic updates to the software used by the vehicle to provide the navigation service. Regardless of the particular motivation for making a change to a software application related to a vehicle, such changes typically require the loading of new or modified software files onto some type of device within the vehicle, such as a vehicle hard drive or some other memory mechanism known in the art.

The loading of software onto a vehicle can be cumbersome, time consuming, costly, and generally inefficient. Typically, the act of modifying software for vehicle systems requires the owner of the vehicle to bring the vehicle in to a dealership or mechanic. It would be desirable in many circumstances for the software within a vehicle to be modified without the need for the owner or user of the vehicle to bring the vehicle to a third party. The desirability of avoiding third-party interactions is particularly applicable when the application is a discretionary or recreational application that does not impact the core functionality of the vehicle.

One mechanism by which new software files can be loaded onto a vehicle hard drive would be by placing the software files onto a CD-ROM that can be placed into the CD player of the vehicle. This approach is very time-consuming. The computer power of on-board or embedded computers in a vehicle is typically very limited. Unlike general purpose computers which can reallocate CPU resources depending on the current needs of the current user, embedded computers in a vehicle do not offer the same flexibility. Thus, using a vehicle CD player to load software upgrades and other changes to software functionality can in many respects, merely transfer the time commitment of seeking out a third party into a time commitment for loading the software.

General purpose computers are better suited for loading software files onto a vehicle hard drive, than the more specialized and embedded computer devices within the traditional vehicle. Software could be provided to drivers and other vehicle users through a variety of different means, including the mailing of CD-ROMs or DVDs, as well as transmission of such software files through electronic means such as e-mail and Web Site downloads. Recipients of the software files could then load the vehicle software onto their vehicle hard drives through a variety of different means, including wireless networks (including but not limited to 802.11b connections) as well as more traditional connections (including but not limited to a USB line).

The challenge of distributing software to vehicles through general purpose computers accessible be vehicle owners is that such software would then be ripe for unauthorized copying and distribution. It would be desirable if manufacturers and suppliers of software applications and support files for vehicle use could prevent the unauthorized copying and distribution of their software files. One way that this could be done would be through the use of various encryption regimes. For example, the software to be distributed could be encrypted so that only a certain vehicle or class of vehicles can access it. The encryption key for a particular software file could be a unique vehicle identification number (VIN), a vehicle classification or model, a vehicle dealership, an attribute associated with the vehicle owner, or virtually any other attribute that is useful in distinguishing vehicle owners and vehicles.

The existing art does not disclose or even hint at or suggest the advantages identified above. The conceptual framework of designing and building software applications for embedded computers is distinct from the conceptual framework for designing and building software applications for general purpose computers. The existing art of vehicle application programming affirmatively teaches away from the incorporating of general purpose computers to interact with embedded vehicle computers, and from the importing of general purpose software design and implementation techniques into the specialized world of embedded software.

### SUMMARY OF THE INVENTION

The present invention relates generally to systems or methods for distributing software from a “source” to a “target” (collectively a “software distribution system” or simply the “system”). More specifically, the present invention relates to software distribution systems where the “target” is a vehicle.

The distribution system can use a variety of devices to load a variety of different vehicles with a wide range of different vehicle software files. A source device can be used to create the software to be loaded onto one or more vehicles. Typically, such software is loaded onto the hard drive of the vehicle, but other storage technologies such as flash memory can also be used depending on the nature of the application. A transmission device can be used to transmit an encrypted copy of the software file to one or more recipient devices associated with one or more vehicle owners. In some embodiments, the transmission device is also the source device. Vehicle owners can receive the transmitted software files through a wide variety of recipient devices that range from the traditional mailbox, to advanced portable wireless devices capable of downloading large files. Vehicle owners and software recipients can then load the encrypted copies of the software onto the hard drives of their various vehicles from a load device. In many embodiments, the load device may also be the recipient device.

In a preferred embodiment of the invention, the unique vehicle identification number (VIN) serves as the encryption key for each copy of the software files so that only the specific vehicle can make use of the distributed copy.

The present invention will be more fully understood upon reading the following detailed description in conjunction with the accompanying drawings and the following detailed description.

### BRIEF DESCRIPTION OF THE DRAWINGS

The present invention will now be described, by way of example, with reference to the accompanying drawings, in which:

FIG. 1 is a process flow diagram illustrating an example of an environmental view of a software distribution system.

FIG. 2 is a block diagram illustrating an example of a subsystem-level view of a software distribution system that includes two subsystems.

FIG. 3 is a block diagram illustrating an example of a subsystem-level view of a software distribution system that includes three subsystems.

FIG. 4 is a block diagram illustrating an example of a subsystem-level view of a software distribution system that includes four subsystems.

FIG. 5 is flow chart diagram illustrating an example of a software supplier using the software distribution system to distribute software.

FIG. 6 is a flow chart diagram illustrating an example of a recipient loading software received through the use of the software distribution system.

### DETAILED DESCRIPTION

I. Introduction of Elements

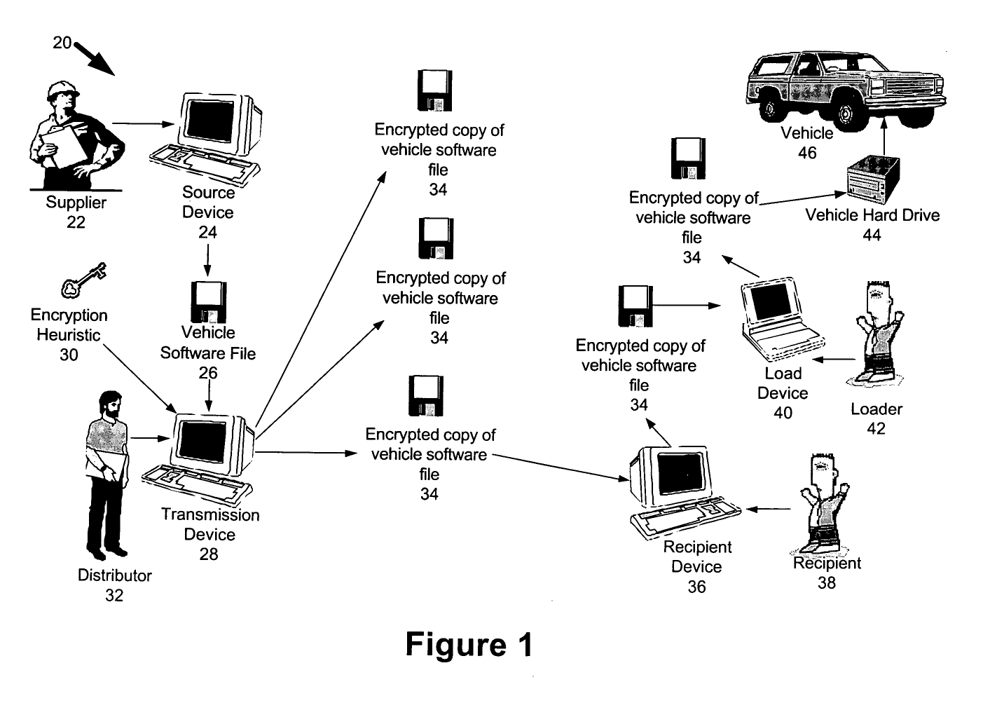

Referring now to the drawings, FIG. 1 is a process flow diagram illustrating an example of an environmental view of a software distribution system 20. The system 20 is highly flexible and configurable, capable of supporting many major and minor variations of what is disclosed in FIG. 1.

A. Suppliers

A supplier 22 is typically a human being who creates a software file 26 with the intention of having that software file 26 loaded onto one or more vehicles 46. In some embodiments, the supplier 22 may be an automated code generator, an expert system, a neural network, an artificial intelligence device, or any other automated means (collectively “intelligence technology”) that can be used to create software applications and related files (collectively “vehicle software files” 26) for use in vehicles 46. The supplier 22 should typically have the technical expertise to create vehicle software files 26 for use in vehicles 46,

In many embodiments, the supplier 22 will be affiliated with an organization that manufactures the vehicle 46, manufactures one or more components of the vehicle 46, or provides a service to vehicle users that is related in some fashion to the vehicle. For example, the supplier 22 may be affiliated with the organization that provides navigation applications, entertainment applications, and other discretionary or recreational functionality for the vehicle 46. In some embodiments of the system 20, the supplier 22 provides such functionality on a subscription basis directly with the various users of the vehicle 46. In other embodiments, the supplier 22 may perform activities as a supplier of the vehicle manufacturer.

Although only one supplier 22 is illustrated in the diagram due to a lack of space, there can be large teams of suppliers 22 working on a single vehicle software file 24 to be loaded onto one or more vehicles 46 using the system 20.

B. Source Device

A source device 24 is any individual device or collection of different devices that are used by one or more suppliers 22 to create the vehicle software files 24 to be loaded onto various vehicles 46. Examples of source devices 24 include but are not limited to desktop computers, laptop computers, work stations, mini-computers, servers, mainframe computers, supercomputers, as well as various client devices for a variety of different networks such as wide area networks (WANs), local area networks (LANs), intranets, extranets, the Internet, and other types of networks (collectively “computer devices”). Typically, source devices 24 will involve a keyboard that is convenient for the purposes of drafting source code instructions for various computers. However, devices not typically associated with “hard core” computer programming can constitute source devices 24. Examples of less traditional source devices include various “portable computing devices.” Examples of portable computing devices include but are not limited to personal digital assistants (PDAs), cell phones, satellite pagers, tablet computers, and other small computers and client devices.

Although only one source device 24 is illustrated in the diagram due to a lack of space, there can be large numbers of source devices 24 supporting the creation of a single vehicle software file 24 to be loaded onto one or more vehicles 46 using the system 20. Moreover, the system 20 need not include a source device 24. For example, the system 20 can be used to distribute vehicle software files 24 that have already been created outside of the system 20.

C. Vehicle Software File

A vehicle software file 26 is any source code or object code file to be loaded onto one or more vehicles 46. The vehicle software file 26 is typically in an object code format because object code is the format actually used by the computers within the vehicle 46, and the distribution of object code in contrast to source code better protects the proprietary rights of the supplier 22. However, in certain circumstances, it may be desirable to for the vehicle software file 26 to be in a “source code” format so that a recipient 38 or loader 42 of the vehicle software file 26 would be able to make modifications to the file. One example in which this might be useful would be the ability of drivers or vehicle owners to create various “profiles” that would impact how they interact with their applications. For example, the vehicle application file 26 might be a chart of user preferences that could be modified by the user.

Typically, each use of the system 20 will involve more than a single vehicle software file 26, although there may be instances were only a single vehicle software file 26 is loaded onto a vehicle 46. Vehicle software files 26 include software applications as well as ancillary files referenced by those applications or used to support those applications (collectively “vehicle software files” or simply “files” 26). Files can be created using a wide variety of different languages, including object-oriented languages such as C++, network independent languages such as JAVA, 4GL programming tools such as Visual Basis, or any other “programming” language or toolkit.

Vehicle software files 24 can potentially relate to wide variety of vehicle functions. Some applications can be classified as purely “recreational” applications because they pertain to entertainment functionality that is not specific to the use of a vehicle 46. Video games, DVD players, and other technologies are examples of “recreational” applications. Other applications can be classified as “discretionary” applications because they relate to the use of the vehicle 46, but they are not necessary for the vehicle 46 to function. Various navigation applications are examples of “discretionary” applications. In some embodiments of the system 20, applications that are “fundamental” to the operation of the vehicle 46 may be processed by vehicle owners instead of having the vehicle owners go to dealerships, mechanics, or other third parties. However, due to the potential safety and the potential liability issues associated with such functions, suppliers 22 may decide to forgo use of the system 20 with respect to “fundamental applications.” In many embodiments, fundamental applications are stored on memory components that are not accessible by users of the vehicles 46. It is probably not desirable to allow a user to negatively impact the way a safety application such as “brakes” would function.

D. Distributor

A distributor 32 is typically a human being responsible for distributing the vehicle software file(s) 24 to the appropriate recipients 38. In some instances, the distributor 32 can be a “technical” user (a person with an expertise relating to information technology), while in other embodiments, the distributor 32 may simply be someone charged administratively with managing the distribution process, a function that can be performed by non-technical users. Distributors 32 need not be human beings. Automated technologies including the intelligence technologies identified above, as well as other types of computer programs and business support software can constitute distributors 32 interacting with the system 20. The distributor 32 interacts with the system 20 through the use of a transmission device. The distributor 32 can design one or more distribution heuristics that determine which files 24 are sent to which recipients 38.

In some embodiments of the system 20, one or more distributors 32 function as suppliers 22, and one or more suppliers 22 function as distributors 32.

E. Transmission Device

A transmission device 28 is any device that allows the distributor 32 to distribute or transmit one or more files 24 (or copies of files) to one or more recipients 38. In some embodiments of the system 20, transmission devices 28 are source devices 24, and source devices 24 are transmission devices 28. Any device described above as a potential source device 24 is capable of being incorporated into the system 20 as a transmission device 28. Although only one transmission device 28 is disclosed in the Figure due to space constraints, a variety of different transmission devices 28 can be used to distribute a single vehicle software file 26 to a variety of different recipients 38 and loaders 42.

F. Encryption Heuristic

In a preferred embodiment of the system 20, the vehicle software files 26 are encrypted so that they can be freely distributed without allowing third parties to easily copy and distribute the vehicle software files 26 at the expense of the proprietary rights of the supplier 22 or other owner of the software. A wide variety of different encryption techniques known in the art can be used to limit the unauthorized copying, transmitting, loading, and/or running of the vehicle software files 26. In a preferred embodiment, the encryption does not limit the activities of copying or transmitting. Instead, it is the activities of loading or running the vehicle software files 26 that are precluded by the encryption. The encryption used by the system 20 can include a variety of encryption key methodologies. Encryption keys can take into consideration a wide variety of potentially relevant attributes, including: one or more vehicle attributes (such as make of the vehicle, model of the vehicle, vehicle identification number (VIN), etc.); one or more recipient attributes (such as social security number, drivers license number, IP address, mailing address, etc.); combinations of vehicle attributes and/or recipient attributes; or any other information types potentially relevant or useful for identifying individual or groups of vehicles.

In a preferred embodiment, a vehicle identification number (VIN) is used as the encryption key. In other embodiments, different unique identifiers can be used, and even non-unique identifiers can be used. For example, an auto dealership could create or provide vehicle software files 24 that would be usable on any vehicle purchased from that dealership. Other examples of non-unique encryption keys would include identifiers relating to the category of vehicle, a geographical region, a household, etc. Even in non-unique encryption approaches, it may be useful to store a unique vehicle identifier that is stored in relation to other non-unique attributes.

G. Encrypted Copies of Vehicle Software Files

As illustrated in the Figure, a single vehicle software file 26 can be distributed to many different potential recipients 38. Thus, in many embodiments of the system 20, what is being distributed from the distribution device 28 is actually a copy of the vehicle software file 34. In preferred embodiments, as discussed above, the copy of the vehicle software file is typically an encrypted copy of the vehicle software file 34 because a preferred embodiment uses one or more encryption heuristics as discussed above. In alternative embodiments not utilizing encryption, the copies of the vehicle software files 34 are subjected to copying just as any other unprotected general purpose software file. In both encryption and encryption-free embodiments, the copies of vehicle software files 34 will typically be in an object code format.

For mass-production and distribution purposes, multiple copies of vehicle software files 34 can be generated in a simultaneous or substantially simultaneous manner. For example, copies of vehicle software files 34 relating to a particular category of vehicles 46 can be created in a single production process. Such copies 34 can also be transmitted in a simultaneous or substantially simultaneous manner.

With the possible exception of the encryption, the vehicle software file copies 34 are typically identical to the initial vehicle software file 24, and thus vehicle software file copies 34 can also be referred to as vehicle software files 34 or simply files 34.

H. Transmission Mechanisms

A wide variety of different transmission formats, embodiments, forms of communications, and transmission mediums (collectively “transmission mechanisms”) can be used to transmit the vehicle software files 34. The types of distribution mechanisms will typically depend on the form in which means by which the vehicle software files 34 are. For example, the vehicle software files 34 can be stored on a tangible medium such as a DVD, a CD, a floppy disk, or some other tangible medium (collectively “tangible medium embodiments”) that can be shipped physically using some type of shipping service or the U.S. Post Office. Other embodiments of the system 20 may involve purely intangible vehicle software files 34 (“virtual medium embodiments”) that are not stored on any type of tangible medium. The distribution virtual medium software files 34 can occur through e-mail attachments, web site downloads, or other electronic means that do not require the transportation of a physical or tangible embodiment of the vehicle software files 34.

I. Recipient

A recipient 38 is typically the human being who is “target” of the vehicle software file 34 sent by the distributor 32. The recipient 38 generally has some type of relationship with the vehicle 46, and is often the owner of the vehicle 46. In certain embodiments, the recipient 38 could be a third-party such as a mechanic or automobile dealership that provides services relating to vehicles 46 on behalf of vehicle owners.

In many embodiments of the system 20, the recipient 38 is also a loader 42, the person responsible for installing the software file 34 onto the vehicle 46. In those embodiments, the potential distinctions between loader 42 and recipient 38 are not applicable.

In certain embodiments, the recipient 38 could be some type of automated agent or other form of intelligence technology, as defined above, that works on behalf of an individual or organization with respect to the vehicle 46.

The recipient 38 need not be a technical user, as defined above. A general familiarity with the use of general purpose computers (e.g. the ability to download a file from a web site) is all the expertise required to be a recipient 38 receiving files 34 through the system 20. The recipient 38 receives the vehicle software file 34 through one of various recipient devices 36.

J. Recipient Device

A recipient device 36 is any device by which the recipient 38 receives the vehicle software file 34. In a preferred embodiment of the system 20, the recipient device 36 is some type of general purpose computer. The examples of “computer devices” and “portable computer devices” provided above include many examples of general purpose devices. Even items such as cell phones, PDAs, and other portable computer devices are becoming closer and closer to full-fledged general purpose computers.

In the context of an intangible copy of the vehicle software file 34 being distributed using a virtual transmission mechanism, the recipient device 36 is the device by which the recipient 38 receives the electronic transmission from the transmission device 28. Thus the recipient device 36 is can be the means by which the file 34 is downloaded from a web site, or saved as an attachment to an e-mail.

In the context of vehicle software files 34 embedded into a tangible storage unit, the recipient device 36 is not necessarily a computer of any type. A mailbox could constitute a recipient device 36 utilized by the system 20.

K. Load Device

A load device 40 is any device by which the vehicle software file 34 is loaded onto the vehicle 46. The load device 40 is typically a general purpose computer, and can in many instances by a portable general purpose computer such as a laptop computer or desktop computer. Any of the devices describe above as potential examples of source devices 24 could be used by loaders 42 as load devices 40.

In many embodiments, the load device 40 is the same device as the recipient device 36. In other embodiments, the file 34 must be delivered by the recipient device 36 to the load device 40. This can be done in a wide variety of different manners. In a tangible medium embodiment, the tangible medium can be physically manipulated to allow access to the information. In other words, the CD-ROM, DVD, floppy disk, or other medium can simply be carried over to the load device 40, and loaded onto the load device 40.

The software file 34 can also be transmitted from the recipient device 36 to the load device 40 using any of the various electronic mechanisms described above that are used by the transmission device 28 to transfer the software 34 to the recipient device 36. Communication methodologies can include wireless networks (such as 802.11b technologies) and other forms of local wireless and non-local wireless technologies. Communication methodologies can also include physical wiring connections, such as a USB cable or any other form of cable known in the art to connect with general purpose computers.

L. Loader

A loader 42 is typically a human being, but may also be in certain circumstances, a device employing some type of intelligence technology as identified above. The loader 42 is any person or device responsible for loading files 34 onto the information technology components of the vehicle 46. In many embodiments, the loader 42 is also the recipient 38. Although only one recipient 38 and one loader 42 are disclosed in the Figure, multiple recipients 38 and multiple loaders 42 can receive the same software file 24, or essentially the same software file 34 in the case of software files 34 that are encrypted on a unique basis.

In a preferred embodiment, the loader 42 need not be technical user, so long as the loader 42 has a passing familiarity with general purpose computers to the extent of connecting a USB cable, or initiating a transfer using a wireless router.

M. Loading Technologies

A wide variety of technologies and techniques can be used by the system 20 to load files 34 from the load device 40 to the vehicle 46. In wired embodiments, the general purpose computer that is the load device 40 is connected to the vehicle 46 or an information technology component of the vehicle 46, such as a removable hard drive, through the use of a wire or other structural connection such as a USB line, or any other connection mechanism known in the art with respect to general purpose computers. In wireless embodiments, the load device 40 establishes a wireless connection with the vehicle 46 (using for example, an 802.11b connection), and loads the various files 34 without any type of structural or mechanical connection. In removable hard drive embodiments, a vehicle hard drive 44 can be removed from the vehicle 46, and installed directly into the load device 40. This method can be extremely convenient in the context of a laptop computer loading device 40 for which it is easy to “swap out” and “swap in” hard drives.

Regardless of the particular method for transferring the file 34, the ability to use general purpose computers as load devices 40 provides a significant time advantage for loading files 34 onto vehicles 46. Unlike embedded computers which have little flexibility to shift what are very limited processing resources, general purpose computers typically have tremendous flexibility and more than robust processing power. Using a general purpose load device 40 to load the files 34 should result significant times savings relative to the use of embedded and specialized vehicle computers to perform the same function. Time savings associated with the use of general purpose computers can reduce by 50%, 70%, or even 90% the amount of time needed to load the various files 34. The use of a general purpose load device 40 also allows the supplier 22 or distributor 32 to assist in the implementation of the files 34 through the use of a user interface that is user friendly, and usable by non-technical personnel.

For example, the software files 34 could include an application for managing the loading options made available to each recipient 38 and or loader 42. Default loading options can be created, as can various user profiles that impact those default selections. By making the experience as user friendly as possible, non-technical personnel can effectively perform a task that is currently performed by high specialized and technical people, at significant time and expense. The system 20 can include user profiles for every step in the process, supplier profiles, distributor profiles, recipient profiles, load profiles, and vehicle profiles can be supported by the system 20 in order to provide as much “intelligence” as possible to the processing performed by the system 20.

N. Storage Medium

A vehicle hard drive 44 is a typical storage medium for storing vehicle software files 34 on the vehicle 46. Alternative embodiments of the system 20 need not include a vehicle hard drive 44. For example, the vehicle software file 34 could be loaded into flash memory, or any other storage mechanism known in the art. In some embodiments of the system 20, the vehicle hard drive 44 is a removable vehicle hard drive, facilitating an additional option for loading the software files 34 to the vehicle 46.

O. Vehicle

A wide variety of different vehicles 46 can receive vehicle software files 34 through the use of the system 20. In many embodiments of the system 20, the vehicle is some type of commercially available automobile, typically sold through an auto dealership. In alternative embodiments, the vehicle 46 can be any mode of transportation, including both powered and non-powered transportation mechanisms. Airplanes, boats, submarines, motorcycles, trucks, mopeds, bicycles, skateboards, hand gliders, helicopters, recreational vehicles, roller skates, spacecraft, and any other transportation device can be vehicles 46 for the purposes of processing by the system 20.

Different vehicles 46 benefiting from the system 20 can have a wide variety of different information technology architectures. For example, a six-seat plane will likely involve information technology components and functionality of greater complexity than a bicycle with certain navigation aids.

II. Subsystem-Level Views

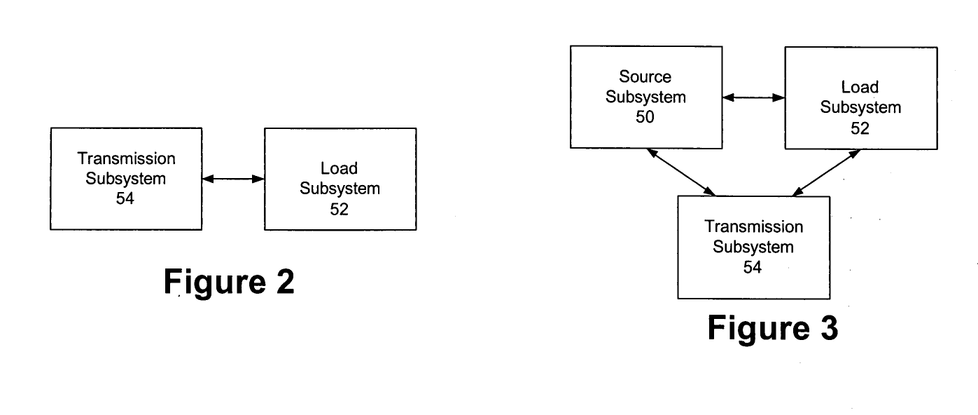

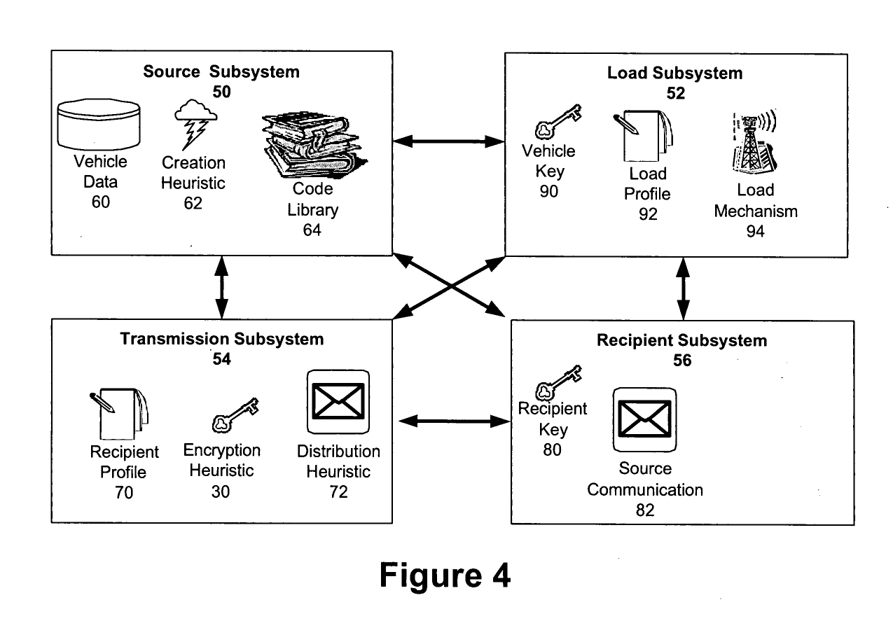

FIG. 2 is a block diagram illustrating an example of a subsystem-level view of a software distribution system 20 that includes two subsystems, a transmission subsystem 54 and a load subsystem 52. FIG. 3 is a block diagram illustrating an example of a subsystem-level view of a software distribution system that includes three subsystems, a source subsystem 50 in addition to the transmission subsystem 54 and load subsystem 52 of FIG. 2. FIG. 4 is a block diagram illustrating an example of a subsystem-level view of a software distribution system that includes four subsystems, including a recipient subsystem 56.

In many embodiments of the system 20, the recipient 38 is also the loader 42 (e.g. one user serves as both roles), and the load device 40 is also the recipient device 36 (e.g. one device serves as both devices). Thus, FIG. 3 discloses a subsystem-level view that is likely to be a more common embodiment than the configuration of FIG. 4.

Similarly, in some embodiments of the system 20, the process of creating the vehicle software file 26 and distributing the vehicle software file 34 are not distinct from each other. In such embodiments, the source device 24 is the transmission device 28, and the supplier 22 is typically the same as the distributor 32. The difference between the configuration displayed in FIG. 2 and the configuration displayed in FIG. 3 is that in FIG. 2, there is no pronounced difference between the creation and distribution of the vehicle software file 24. The example in FIG. 2 also corresponds to a situation where the system 20 is used to distribute software that is created outside the confines of the system 20. In certain embodiments of the system 20, the distributor 32 obtains software from outside the system 20 (often a third-party) and those thus embodiments of the system 20 will not include the source subsystem 50.

A. Transmission Subsystem

A transmission subsystem 54 can be used for all functionality relating to the transmission of one or more files 34 to one or more recipients 38 or loaders 42. The transmission subsystem 54 typically includes one or more distributors 32 and one or more transmission devices 28. In a two-subsystem embodiment, the transmission subsystem 50 is responsible for every activity on the “supply” side of the distribution equation. Every embodiment of the system 20 requires some type of transmission subsystem 54, because distribution of software files 34 is the focus of the system 20.

As illustrated in FIG. 4, some embodiments of the transmission subsystem 54 are responsible for interacting with and responding to information contained in various recipient profiles 70 maintained by the system 20. For example, one recipient 38 may prefer to receive updates immediately after they are available, and that recipient 38 may prefer to receive such updates through a web site. In contrast, another recipient 38 may prefer to limit updates to a certain number of times a year, and that recipient may desire to receive files 34 in the form of a DVD that is mailed to a work-related address.

The means by which distributors 32 automate the distribution process is through the creation, updating, deletion, and enforcement of one or more distribution heuristics 72. Distribution heuristics 72 are preferably designed to interact with various profile attributes, whether those profile attributes are express preferences of the particular recipient 38, or whether the recipient profile 70 relies more heavily on the actual past conduct or other more objective attributes relating to the recipient 38.

The encryption heuristic 30 discussed above is also typically a function of the transmission subsystem 54, although in certain embodiments, it can be a function of the source subsystem 50.

In an embodiment of the system 20 that does not include a source subsystem 50, the transmission subsystem 54 can include the functionality attribute to the source subsystem 50 described below.

B. Load Subsystem

A load subsystem 52 can also be referred to as a “target subsystem.” The load subsystem 52 can include a variety of information technology components and heuristics relating to the loading of one or more files 34 onto the information technology architecture of the vehicle 46. In a two-subsystem embodiment, the load subsystem 52 is responsible for every activity on the “demand” side of the distribution equation. Every embodiment of the system 20 requires some type of load subsystem 52, because loading files 34 is the goal of the system 20.

As illustrated in FIG. 4, the load subsystem 50 can access various encryption keys, including a vehicle key 90 for unique vehicle identification purposes (such as a VIN). The load subsystem 52 can also provide for the creation, updating, and deletion of one or more load profiles 92 and other user-selected options relating to exactly how the files 34 are loaded onto the vehicle 46. The load subsystem 52 can provide many different loading options and can configure the various load mechanisms 94 that are available.

In some embodiments, the load subsystem 52 is responsible for recipient activities, which can include communications 82 with the source of the files 34 as well as recipient keys 80 for encryption purposes.

C. Source Subsystem

A source subsystem 50 can also be referred to as a supplier subsystem 50. The source subsystem 50 can include a variety of information technology components and heuristics relating to the creation and distribution of the vehicle software files 26.

As illustrated in FIG. 4, the source subsystem 50 can access a database of vehicle data 60 in generating the various files 34 for distribution. Different classes of vehicles 46 may involve different customizations and data parameters that are relevant to the purposes of the software files 34 being distributed. A wide variety of different creation heuristics 62 can be used to actually create the various files 34, and a modular design of creation tools can be desirable in embodiments where different categories of vehicles 46 may be associated with particular values relating to more generalized types of data. In order to enhance the efficiency of the various creation heuristics 62, a code library 64 (including such things as object libraries and other development tools) can be accessed by the source subsystem 50.

D. Recipient Subsystem

A recipient subsystem 56 can incorporate all functionality relating to the receipt of files 34 from the transmission subsystem 54. Many embodiments of the system 20 will not include a recipient subsystem 56, because in many instances, the recipient 38 and loader 49 are the same person, an individual consumer and a non-technical user. The recipient subsystem 56 can include the means for the recipient 38 to configure their recipient profile 70 that is then stored on the transmission subsystem 70. The recipient subsystem 56 can also be responsible for generating communications 82 with the “supply” side of the system 20.

III. Process-Flow Views

A. “Supply Side” or “Source Side” Process Flow

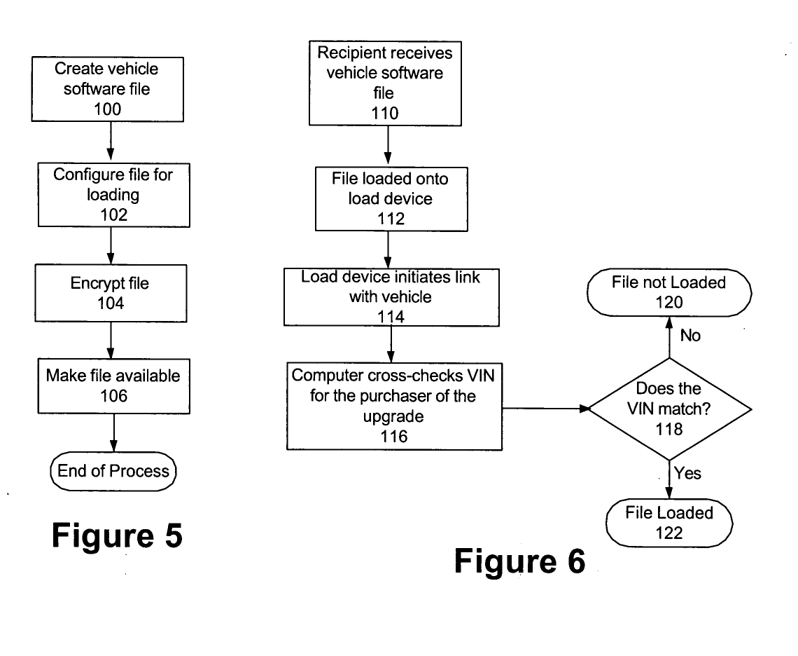

FIG. 5 is flow chart diagram illustrating an example of a software supplier using the software distribution system 20 to distribute a vehicle software file 34.

At 100, the vehicle software files 26 are created. Suppliers 22, source devices 24, software files 26, and the source subsystem 50 are described above.

At 102, the vehicle software files 26 are configured for loading onto the various vehicles 46 making up the “target” for the files 34. In some circumstances, the files 34 could be specifically designed for one particular vehicle 46. In other embodiments, groups of vehicles 46 can be the “target” for the files 34. This step in the process can include providing application software to assist loaders 42 in the loading process. Such assistance-oriented software would typically not be loaded on to the vehicle 46.

At 104, the file 34 or files 34 are encrypted. As discussed above, in a preferred embodiment, a unique vehicle identifier such as a VIN number, is the key for the encryption heuristic 30.

At 106, the supplier 22 makes the file 34 available to the recipient 38. This can be done in a variety of different ways. A copy of the tangible medium such as a CD, DVD, or other tangible storage unit can be shipped to the recipient 38. In intangible embodiments, the file 34 can be transmitted electronically in an affirmative manner, such as an e-mail attachment, or in ways that are more passive, requiring affirmative action by the recipient 38 to actively seek out the file 34. An example of a passive transmission mechanism is a web site accessible by the recipient 38 from which the recipient 38 can download the vehicle software file 34.

B. “Demand Side” or “Target Side” Process Flow

FIG. 6 is a flow chart diagram illustrating an example a recipient 38 of a vehicle software file 34 distributed using the software distribution system 20.

At 110, the recipient 38 or loader 42 accesses the files 34 in one or more of the numerous ways discussed above.

At 112, the files 34 can then be loaded onto the load device 40.

At 114, the load device 40 initiates a link with the vehicle 46. This can be carried out in many different ways, as discussed above.

At 116, the load device 40 cross checks the vehicle key 90 such as a VIN number to make sure that the vehicle 46 is associated with an authorized licensee, purchaser, or subscriber of the software files 34. If the VIN number or other unique identifier at 118 does not match, the file 34 is not loaded at 120. If the loading is appropriate at 118, then the file 34 is loaded at 122. Either way, the process then ends.

IV. Alternative Embodiments

It should be understood that various alternatives to the embodiments of the invention described herein may be employed in practicing the invention. It is intended that the following claims define the scope of the invention and that the method and apparatus within the scope of these claims and their equivalents be covered thereby.

1. A system for distributing software to a storage medium located on a vehicle, said system comprising:
a transmission device, a load device, and a vehicle software file;
wherein said transmission device provides for making said vehicle software file accessible to said load device;
wherein said load device is a general purpose computer; and
wherein said load device provides for loading said vehicle software file onto the vehicle storage medium.

2. The system of claim 1, further comprising a recipient device, wherein said recipient device provides for receiving said vehicle software file from said transmission device, and wherein said recipient device provides for distributing said vehicle software file to said load device.

3. The system of claim 1, further comprising a source device, wherein said source device provides for creating said vehicle software file, and wherein said source device provides for

4. The system of claim 1, wherein said transmission device provides for transmitting an encrypted copy of said vehicle software file, wherein said vehicle software file is encrypted using a vehicle attribute.

5. The system of claim 4, wherein said vehicle attribute is a unique identifier.

6. The system of claim 5, wherein said unique identifier is a vehicle identification number.

7. The system of claim 1, wherein said load device is operated by a non-technical user.

8. The system of claim 1, wherein said vehicle software file is made accessible to said load device in a tangible medium.

9. The system of claim 8, wherein said tangible medium is mailed to a recipient device associated with said load device.

10. The system of claim 1, wherein said load device provides for loading said vehicle software file onto the vehicle storage medium through a wireless network.

11. The system of claim 1, wherein a single said transmission device transmits a plurality of vehicle software files to a plurality of recipient devices, wherein each transmitted vehicle software file has a unique encryption key based on a vehicle identification number.

12. The system of claim 11, wherein each said unique encryption key allows each said vehicle software file to run on only one specific vehicle storage medium.

13. The system of claim 1, wherein said vehicle software file is an upgrade to a navigation application.

14. The system of claim 1, wherein said transmission device provides for making said vehicle software file accessible to said load device by: (a) creating and mailing a CD-ROM to an address associated with said load device; (b) creating and mailing a DVD to an address associated with the load device; (c) e-mailing said vehicle software file as an attachment; (d) making said vehicle software file downloadable from a web site.

15. The system of claim 1, wherein said load device loads said vehicle software file onto the vehicle storage medium in less than 75% of the time it would take the vehicle software file to load from a CD-ROM drive within the vehicle.

16. The system of claim 1, wherein said load device loads said vehicle software file onto the vehicle storage medium by connecting said load device to vehicle storage medium with as USB connection.

17. A method for distributing software to embedded computers in a plurality of vehicles, comprising:
configuring the vehicle software files so that they can be loaded onto a plurality of vehicle storage mediums by vehicle users using a plurality of general purpose computers;
encrypting the vehicle software files so that each vehicle software file will only function in a subset of vehicles within the plurality of vehicles; and
making the vehicle software files accessible to a plurality of loading devices associated with the plurality of vehicles.

18. The method of claim 17, wherein said plurality of vehicle software files includes a user-assistance file that is not loaded onto any of the vehicle storage mediums.

19. The method of claim 17, wherein the vehicle hard drives are accessible to general purpose computers without removing the vehicle storage mediums from the vehicles.

20. The method of claim 17, wherein the vehicle software files are encrypted with a unique key that is a vehicle identification number.

21. The method of claim 17, wherein the vehicle software files relating to an identical component type are generated and transmitted in a substantially simultaneous manner.

22. The method of claim 17, wherein the loading of the vehicle software file from general purpose computer requires no more than 60% of the time required to load the vehicle software file from a CD-ROM player that is part of the vehicle.

23. The method of claim 17, further comprising installing a vehicle hard drive into the vehicle that is configured to be removable and accessible from the general purpose computer.

24. The method of claim 17, wherein a request for the vehicle software file is sent as an e-mail from a recipient device, and said vehicle software file is received electronically from said recipient device.

25. A method of distributing upgraded vehicle software files to vehicle storage mediums through the use of general purpose computers under the control of vehicle users, said method comprising:
encrypting the vehicle software file using a vehicle identification number as a unique key;
transmitting the vehicle software file to a plurality of different recipients, wherein each recipient receives a copy of the vehicle software file that corresponds to a vehicle identification number unique to the vehicle associated with the recipient and unique to the vehicle software file;
allowing a plurality of recipients to load their particular copy of the vehicle software file onto a vehicle hard drive corresponding to the vehicle identification number corresponding to the encryption key for the particular copy of the vehicle software file; and
prohibiting the loading of any vehicle software file onto a vehicle hard drive where the vehicle identification number for the vehicle does not correspond to the vehicle identification number serving as the encryption key for the vehicle software file.

26. The method of claim 25, wherein a plurality of loading options are made available to each recipient, and wherein a default loading option is automatically identified in accordance with a recipient profile.

27. The method of claim 25, further comprising receiving a plurality of recipient profiles from a plurality of recipients, wherein said recipient profiles specify the frequency of permitted vehicle software file transmissions.

28. The method of claim 25, wherein the vehicle software file relates to an upgrade for a navigation application being paid for by a recipient on a subscription basis.

29. The method of claim 25, wherein a receiving device associated with a recipient initiates a link with the vehicle hard drive.

30. The method of claim 25, wherein the vehicle hard drive is accessible to a plurality of embedded computer devices within the vehicle.

31. The method of claim 25, wherein the recipient receives the vehicle software file through a recipient device, wherein the recipient loads the vehicle software file through a load device, and wherein the recipient device is not the load device.
